(19) United States
(12) Patent Application Publication
(10) Pub. No.: US 2016/0016248 A1
(43) Pub. Date: Jan. 21, 2016

(54) DISPOSITION FOR SIGNALING BY MEANS OF A VIBRATORY SYSTEM PLACED IN EQUIPMENT FOR MEASURING AND ANALYSIS OF WELDING PARAMETERS IN REAL TIME

(71) Applicant: SUMIG SOLUÇOES PARA SOLDA E CORTE LTDA, Rio Grande do Sul (BR)

(72) Inventor: Wilian SUSIN, Rio Grande do Sul (BR)

(21) Appl. No.: 14/802,853

(22) Filed: Jul. 17, 2015

(30) Foreign Application Priority Data
Jul. 18, 2014 (BR) 2020140178037

(51) Int. Cl. B23K 9/095; B23K 31/12; G08B 6/00; B23K 9/32

(52) U.S. Cl. CPC B23K 9/0956; B23K 9/322; B23K 31/125; G08B 6/00

(57) ABSTRACT

A disposition for signaling by means of a vibratory system placed in equipment for measuring and analysis of welding parameters in real time is provided, relating to a monitoring device in real time applied to electrical parameters in “GMAW” (MIG/MAG) and “TIG” welding devices, in the field of welding equipment. In practice, welding machine operators have found it difficult to immediately perceive alarm signals from equipment for measuring and analysis of welding parameters in real time due to variations in the power source, incorrect regulations and process variations caused by faulty placing of the welding torch or gun. A signaling by means of a vibratory system placed in equipment for measuring and analysis of welding parameters in real time is provided, having a vibratory component applied to the welding torch, the welding gun, the mask, EPI or garments, among other strategic sites.

### BACKGROUND OF THE INVENTION

1. Field of the Invention

This utility model patent application is aimed at a signaling device for a peripheral monitoring equipment applied to the power source, more precisely, for “REAL TIME” monitoring equipment of “GMAW” (MIG/MAG) and “GTAW” (TIG) welding parameters which allows the insertion of operation rules, data acquisition, parameter analysis and signaling to the “REAL TIME” operator by means of a “VIBRATORY SYSTEM” applied to the welding torch, mask, EPI or clothing, or even blockage of the machine in critical situations.

The signaling is performed in “Real Time” during the performance of the weld bead by means of a vibratory system applied to the welding torch or gun, mask, EPI or clothing, when the operator exceeds a series of parameters previously set in the monitoring equipment called “Alert Parameters”.

If the operator exceeds the “Alert Parameters” which comprise the acceptable process variables the vibratory signaling system notifies the operator in “REAL TIME” that the values used in performing the weld bead are still acceptable, but are close to a second set of parameters called “Critical Parameters” which must not be exceeded. In this way, the operator may correct the performance of the weld bead and keep the process within ideal parameters.

In the event the operator exceeds the second set of parameters, other parameters are also previously set in the monitoring equipment, which are considered as critical process parameters, and are called “Critical Parameters”, which must not be exceeded, and in this case the “BLOCKAGE” of the machine occurs which prevents the performance of the weld bead from continuing.

Therefore, this patent application describes a signaling device for the operator in “REAL TIME” through a “VIBRATORY SYSTEM” applied to the welding torch, mask, EPI or clothing, or even the device itself, which causes blockage of the machine in critical situations, thus obtaining a differential use and performance as regards other models available in the market, since it aids the operator in “ERROR PREVENTION” and is also useful for training and improvement of welders, gauging welding equipment in accordance with parameters set in the measuring equipment and analysis of welding parameters in real time.

2. Brief Discussion of the Related Art

Protection gas arch welding consists of joining metal parts by means of fusion of materials generated by intense heat, due to controlled passage of electric power at a specific point, with addition of material or not. “GMAW” (gas metal arc welding) welding, also known as “MIG/MAG” (MIG—Metal Inert Gas/MAG—Metal Active Gas), consists of an electric arc welding process between the item and a consumable electrode, placed in the shape of an uncoated wire, provided with a continuous feeder. In this welding method, placement of the melted electrode at the junction of the metal materials performs the joining of the parts. The electric arc resulting from the passing of electricity between the electrode and the welded parts causes a steep temperature rise which produces fusion in a continuous process during welding, which is ensured by the continuous feeding of the electrode. The presence of gas in this process ensures that the welding arc will be isolated from the atmosphere, and may even be an active gas which is a component of the item formed by joining of the welded parts.

“TIG” welding (Tungsten Inert Gas) also consists of electric arc welding between metal parts and a nonconsumable tungsten electrode, whether adding material or not in the form of a wire or a rod inserted in the arc's field of action during the welding process. The presence of gas in this type of welding ensures protection against atmospheric gases.

Although these welding methods have been used for a long time and provide satisfactory results, the great drawback thereof is the multiple variables which might cause quite complex variations during the process, deriving in different joining features, and some of such variations being barely perceivable through non-destructive analyses.

The process variables are electrical features, adjusted according to welding arc tension and current; physical-chemical parameters such as presence of a sufficient gas flow, speed and composition of the consumable electrode (where applicable). Variables may even behave dynamically during the welding process, where the current and tension are influenced by the rate and distance from the welding on the welded item, and also by the diameter and progress rate of the added metal.

Therefore, the issue of repetitive welding lies on the influence of the human factor over the existing process variables, mainly in manual welding.

### SUMMARY OF THE INVENTION

With the aim of monitoring the welding process control, a measuring equipment was developed with a feature for welding parameters measuring and analysis in “REAL TIME” to be fitted into a welding equipment, used for analyzing welding electrical parameters, (Current and tension) in “REAL TIME”, interfering in the process through singling or blockage, the latter being configurable actions, and even performing analysis of non-electrical parameters (gas flow rate, temperature of cooling fluids, speed or amount of wire, time of open arc, which features may be optional or added in product variations), allowing the use of this data in signaling and trigger blockage actions, and also collecting welding parameters, recording collected data in a memory area that may be transferred to a computer subsequently or in “REAL TIME”.

With the aim of improving perception of the signals from the mentioned equipment for measuring and analysis of welding parameters in “REAL TIME”, the subject-matter of this disclosure “DISPOSITION FOR SIGNALING BY MEANS OF A VIBRATORY SYSTEM PLACED IN EQUIPMENT FOR MEASURING AND ANALYSIS OF WELDING PARAMETERS IN REAL TIME”, was developed, which provides the placing at a strategic site of a signaling by means of a vibratory system applied to the welding torch, mask, EPI or garments, which is easily perceived by welding machine operators.

### BRIEF DESCRIPTION OF THE DRAWINGS

In order to facilitate understanding of this disclosure “DISPOSITION FOR SIGNALING BY MEANS OF A VIBRATORY SYSTEM PLACED IN EQUIPMENT FOR MEASURING AND ANALYSIS OF WELDING PARAMETERS IN REAL TIME”, the following illustrative figures are enclosed, wherein:

FIG. 1—Shows a perspective top-front view of the measuring and analysis equipment of welding parameters in real time and components thereof.

FIG. 2—Shows a welding parameters chart showing the regular range of operation, minimum alert range, maximum alert, lowest blockage and highest blockage.

FIG. 3—shows the vibratory component and the microcontroller fitted to the welding torch or gun.

FIG. 4—shows vibration of the welding torch or gun in a continuous mode.

FIG. 5—shows vibration of the welding torch or gun in intermittent mode.

FIG. 6—Shows a welding mask fitted with a vibratory component and the microcontroller.

FIG. 7—Shows the vibratory component and the microcontroller fitted into the glove.

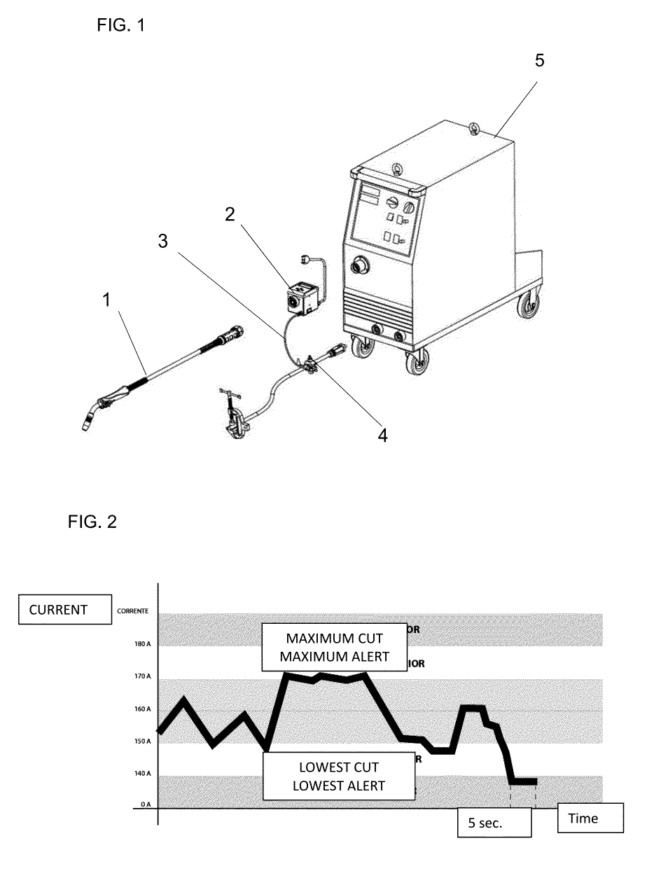

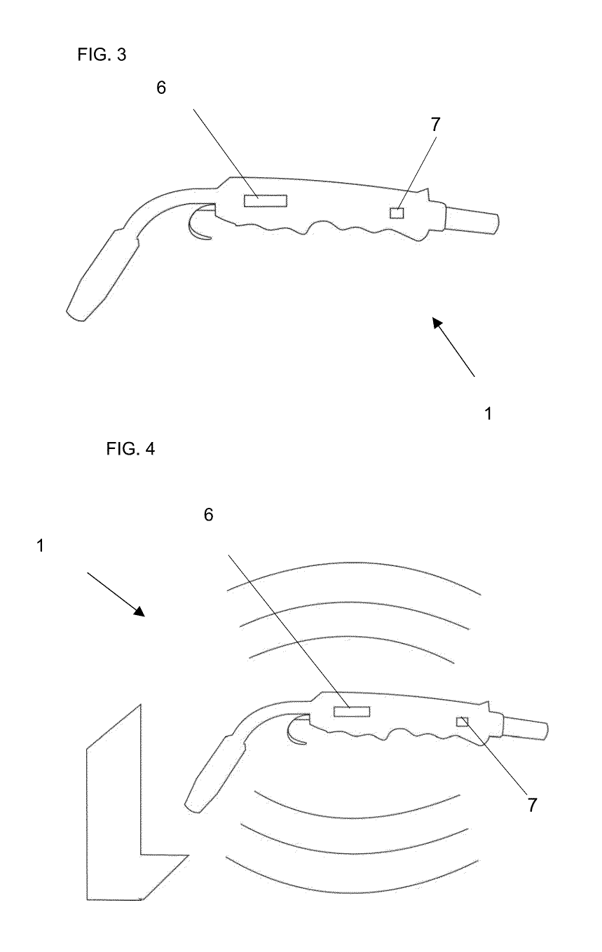

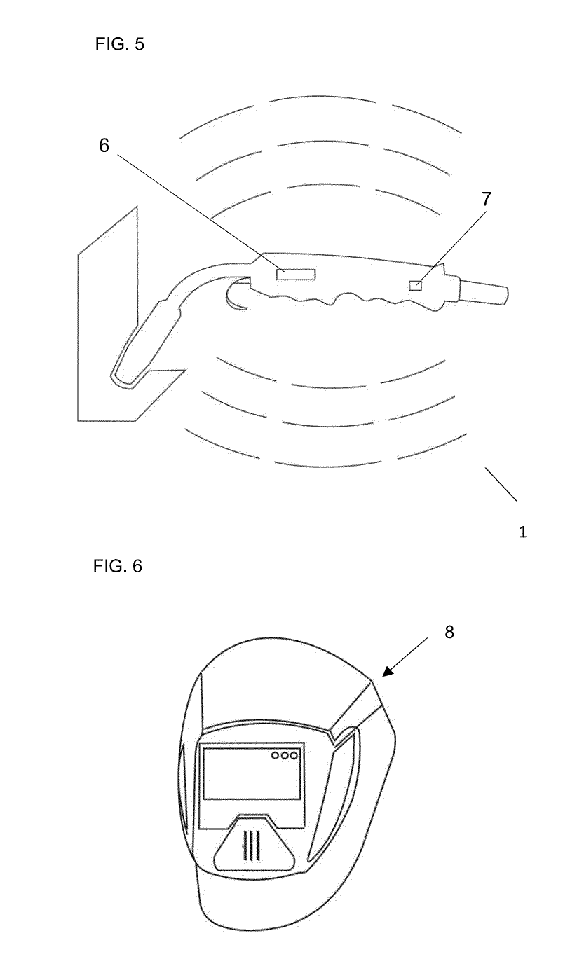

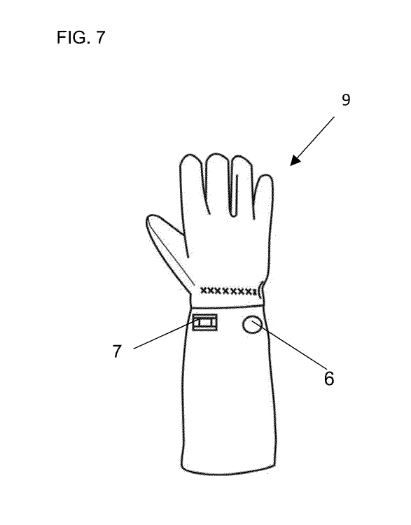

### DETAILED DESCRIPTION OF THE PREFERRED EMBODIMENTS

In accordance to the figures described above, the “DISPOSITION FOR SIGNALING BY MEANS OF A VIBRATORY SYSTEM PLACED IN EQUIPMENT FOR MEASURING AND ANALYSIS OF WELDING PARAMETERS IN REAL TIME” refers to an improvement in the device used for monitoring in real time applied to electrical welding parameters in “GMAW” (MIG/MAG) and “TIG” welding devices, so as to provide an improvement in the quality of the weld bead, training and improvement of new welders, gauging of the power source, and mainly, prevention of errors in performance of the weld bead through signaling to the welding machine operator, composed of a vibratory system which sends signals to the operator in accordance with tension or current parameters in real time, during the performance of the weld bead, using the novel technology.

When tension or current parameters are below ideal tension and current values for performing the weld bead, vibration is continuous, for tension and current parameters above ideal values—deemed as variations of the process, vibration is intermittent.

This is the product's main feature, to notify the operator before a performance error occurs during the job, which might cause a faulty weld bead and therefore a flawed welded item, usually called a non-conforming item.

If the operator exceeds minimum tension and current welding parameters vibration is continuous, for tension and current parameters exceeding critical parameters for a period below what is acceptable, vibration is intermittent.

If the operator exceeds minimum critical current and tension parameters for performing the weld bead during a time exceeding the acceptable period the machine is stopped and vibration is interrupted. Errors are shown in an LCD display showing the operator what kind of error occurred. Two types of error signals are possible when minimum critical parameters are reached for a period of time exceeding the acceptable error period, i.e. sub-tension and current.

If the operator exceeds the maximum tension and current critical parameters while performing the weld bead during a period of time exceeding the acceptable period, the machine is stopped and vibration ceases. So as to notify the operator of an error, the type of error is shown in an LCD display. Two types of error signals are possible when maximum critical parameters are reached during a period of time exceeding the acceptable error period, i.e. excess tension and excess current.

This is another novel feature of this product, as well as preventing errors, in the event they occur the machine is stopped to prevent production of a non-conforming item, as well as notifying the operator of the type of error. In this way, training and improvement of new welders is facilitated due to the interactions of the system with the operator in real time through a “VIBRATORY SYSTEM”, for peripheral monitoring equipment (2), which is connected to the power source (5) and grounded through the conductor (3) and fixed by means of a clamp (4). The vibratory component (6) may be applied to the torch (1) or welding gun, the mask (8), EPI or garments (9), or strategic sites for immediate perception by the operator. For monitoring in real time to take place, use of an embedded microcontroller (7) is necessary.

1. The “DISPOSITION SIGNALING BY MEANS OF A VIBRATORY SYSTEM PLACED IN EQUIPMENT FOR MEASURING AND ANALYSIS OF WELDING PARAMETERS IN REAL TIME”; refers to an improvement in a monitoring device in real time applied to electrical parameters in “GMAW” (MIG/MAG) and “TIG” welding devices, composed of a vibratory system which sends signals to the operator in accordance with tension and current parameters in real time while performing the weld bead, wherein, a vibratory component (6) is applied to the torch (1), the welding gun, the mask (8), EPI or garments (9), among other strategic sites.
